(19) United States
(12) Patent Application Publication
(10) Pub. No.: US 2019/0018294 A1
(43) Pub. Date: Jan. 17, 2019

(54) PIXEL ARRAY SUBSTRATE AND DISPLAY DEVICE

(71) Applicant: Shenzhen China Star Optoelectronics Semiconductor Display Technology Co., Ltd., Shenzhen, Guangdong (CN)

(72) Inventors: Longqiang SHI, Shenzhen, Guangdong (CN); SHU-JHIH CHEN, Shenzhen, Guangdong (CN)

(73) Assignee: Shenzhen China Star Optoelectronics Semiconductor Display Technology Co., Ltd., Shenzhen, Guangdong (CN)

(21) Appl. No.: 15/739,713

(22) PCT Filed: Aug. 22, 2017
(86) PCT No.: PCT/CN2017/098446

§ 371 Date: Dec. 23, 2017

(30) Foreign Application Priority Data
Jul. 17, 2017 (CN) 201710583013.X

(51) Int. Cl. G02F 1/1362

(52) U.S. Cl. CPC G02F 1/136286; G09G 3/3666

(57) ABSTRACT

A pixel array substrate and a display device are disclosed. Wherein, an arrangement direction starting from the first pixel to the second pixel in the pixel unit is defined as a first direction, a conductive sequence of the scanning lines is defined as a second direction. In each of the at least two display regions, the first direction and the second direction are the same, in different display regions, the second directions are the same. The present invention can avoid that in adjacent pixel units, a coupling effect among pixels having different capacitances will make a middle region of the display region to have a larger brightness.

### BACKGROUND OF THE INVENTION

### 1. Field of the Invention

The present invention relates to a pixel array substrate field, and more particularly to a pixel array substrate and a display device for generating a larger brightness at some regions.

### 2. Description of Related Art

Along with the development of the display technology, a large-sized display device (such as 85 inch or 95 inch) has become a research focus. However, along with the increase of size of the display device, a load of the resistor and the capacitor of the data line are also increased, a RC delay is serious so as to cause a wrong charging of a display image.

In the conventional art, a screen splitting method is adopted to the large-sized display device such that the load of the resistor and the capacitor is reduced in half, which can improve the wrong charging of the display image in a certain degree. However, in adjacent pixel units, a coupling effect among pixels having different capacitances will make a middle region of the display region to have a larger brightness so that a display effect of the entire display device is poor. Accordingly, the conventional technology requires to be further improved.

### SUMMARY OF THE INVENTION

The main technology problem solved by the present invention is to provide a pixel array substrate and a display device, which can avoid a larger brightness in a middle region of a display region and poor display effect.

In order to solve the above technology problem, a technology solution adopted by the present invention is: a pixel array substrate, comprising:

multiple pixel units arranged as a matrix, wherein, the multiple pixel units are divided into at least two display regions, each pixel unit includes a first pixel and a second pixel, a capacitance of the first pixel is greater than a capacitance of the second pixel; and

multiple independent scanning lines located at different display regions, each scanning line is coupled to a corresponding first pixel and a corresponding second pixel of the pixel unit in a corresponding display region;

wherein, an arrangement direction starting from the first pixel to the second pixel in the pixel unit is defined as a first direction, a conductive sequence of the scanning lines is defined as a second direction; and

wherein, in each of the at least two display regions, the first direction and the second direction are the same, in different display regions, the second directions are the same.

Wherein, multiple pixel units are divided into two display regions located at an upper and a lower screen, or located at a left and a right screen; or the multiple pixel units are evenly divided into four or above display regions.

Wherein, for multiple pixel units dividing into two display regions located at an upper and a lower screen, or located at a left and a right screen, the number of the pixel units is the same or different.

Wherein, the at least two display regions includes a first display region and a second display region which are disposed adjacently, and the second directions corresponding to the first display region and the second display region are opposite and direct outwardly or inwardly.

Wherein, the first pixel is a sub pixel and the second pixel is a main pixel.

In order to solve the above technology problem, another technology solution adopted by the present invention is: a pixel array substrate, comprising:

multiple pixel units arranged as a matrix, wherein, the multiple pixel units are divided into at least two display regions, each pixel unit includes a first pixel and a second pixel, a capacitance of the first pixel is greater than a capacitance of the second pixel; and

multiple independent scanning lines located at different display regions, each scanning line is coupled to a corresponding first pixel and a corresponding second pixel of the pixel unit in a corresponding display region;

wherein, an arrangement direction starting from the first pixel to the second pixel in the pixel unit is defined as a first direction, a conductive sequence of the scanning lines is defined as a second direction; and

wherein, in each of the at least two display regions, the first direction and the second direction are the same, in different display regions, the second directions are different.

Wherein, multiple pixel units are divided into two display regions located at an upper and a lower screen, or located at a left and a right screen; or the multiple pixel units are evenly divided into four or above display regions.

Wherein, for multiple pixel units dividing into two display regions located at an upper and a lower screen, or located at a left and a right screen, the number of the pixel units is the same or different.

Wherein, the at least two display regions includes a first display region and a second display region which are disposed adjacently, and the second directions corresponding to the first display region and the second display region are opposite and direct outwardly or inwardly.

Wherein, the first pixel is a sub pixel and the second pixel is a main pixel.

In order to solve the above technology problem, a technology solution adopted by the present invention is: a display device.

Wherein, the display device further includes the pixel array substrate described above.

Wherein, a size of a screen of the display device is greater than 85 inch.

Wherein, the display device is an LCD display

The beneficial effect of the present invention is: in the present invention, through disposing the first direction and the second direction to be the same in each of the at least two display regions, in the adjacent pixel units inside the display region, a coupling effect is generated between the first pixel under a conductive status and a second pixel under a non-conductive status. Because the capacitance of the first pixel 11 is greater than the capacitance of the second pixel, the coupling effect will not generate an abnormal display in order to effectively avoid a larger brightness in a middle region of a display region and poor display effect because of a coupling effect between pixels having different capacitances in adjacent pixel units.

### BRIEF DESCRIPTION OF THE DRAWINGS

FIG. 1 is a schematic diagram of a pixel array substrate according to the conventional art;

FIG. 2 is a schematic diagram of a pixel array substrate according to an embodiment of the present invention;

FIG. 3 is a schematic diagram of a pixel array substrate according to another embodiment of the present invention; and

FIG. 4 is a schematic diagram of a display device according to an embodiment of the present invention.

### DETAILED DESCRIPTION OF THE PREFERRED EMBODIMENT

The following will combine the drawings and embodiments for illustrating the present invention in detail.

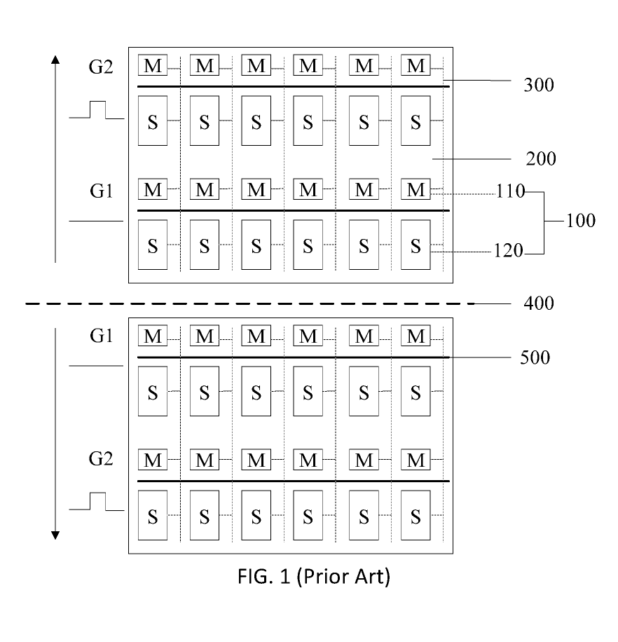

With reference to FIG. 1, and FIG. 1 is a schematic diagram of a pixel array substrate according to the conventional art. In the conventional technology, multiple display regions 200 located at two side of a screen splitting line 400 includes multiple pixel units 100 arranged as a matrix, each pixel unit 100 includes a main pixel 110 and a sub pixel 120. A capacitance of the main pixel 110 is less than a capacitance of the sub pixel 120. In different display regions, arrangement ways of the main pixels 110 and the sub pixels 120 of the pixel units 100 are the same. In adjacent display regions 200, transmission directions of signals of data lines 300 are opposite.

Using directions indicated by arrows in FIG. 1 as the transmission directions of signals, for a display region 200 located above the screen splitting line 400, when a scanning line G1 is turned off, and a scanning line G2 is turned on, the sub-pixel 120 after being charged will be coupled with the main pixel 110 under a non-conductive status. Because the capacitance of the main pixel 110 is less than the capacitance of the sub-pixel 120, in the coupling process, an abnormal display will not be generated. For the display region 200 located below the screen splitting line 400, when a scanning line G1 is turned off, and a scanning line G2 is turned on, the main pixel 110 after being charged will be coupled with the sub-pixel 120 under a non-conductive status. Because a capacitor area of the main pixel 110 is less than a capacitor area of the sub-pixel 120, when a capacitor area is larger, a larger capacitance is formed, the capacitance of the main pixel 110 is less than the capacitance of the sub-pixel 120. In the coupling process, a voltage level of the sub-pixel 120 will be pulled to be far away from a holding voltage level of the sub-pixel 120 such that the display region where the sub-pixel 120 is located generates a larger brightness so that the display effect is poor.

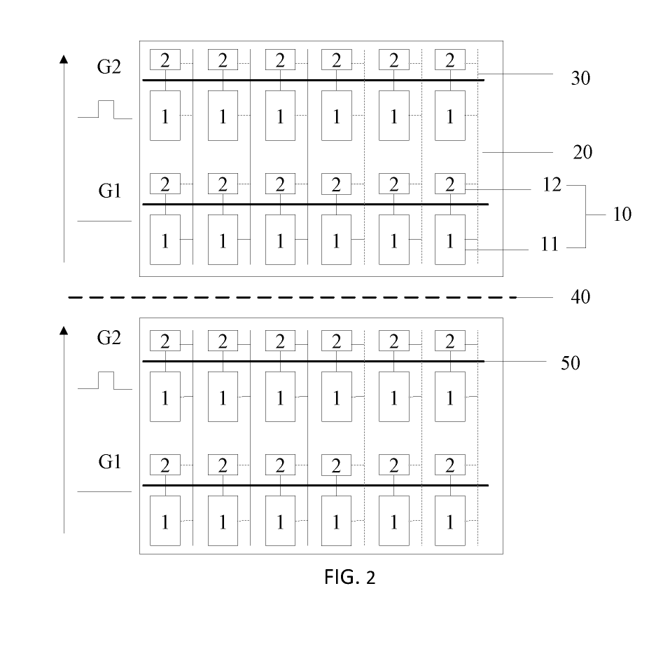

With reference to FIG. 2, and FIG. 2 is a schematic diagram of a pixel array substrate according to an embodiment of the present invention. The pixel array substrate includes: multiple pixel units 10 arranged as a matrix, the multiple pixel units 10 are divided into at least two display regions 20. Wherein, each pixel unit 10 includes a first pixel 11 and a second pixel 12. A capacitance of the first pixel 11 is greater than a capacitance of the second pixel 12. Multiple independent scanning lines 50 and data lines 30 located at different display regions 20. Each scanning line 50 is coupled to a corresponding first pixel 11 and a corresponding second pixel 12 of the pixel unit 10 in a corresponding display region 20.

Wherein, an arrangement direction starting from the first pixel 11 to the second pixel 12 in the pixel unit 10 is defined as a first direction. A conductive sequence of the scanning lines 50 (as an arrow shown in FIG. 2) is defined as a second direction. Wherein, in each of the at least two display regions 20, the first direction and the second direction are the same.

In the present invention, through disposing the first direction and the second direction to be the same in each of the at least two display regions 20, in the adjacent pixel units 10 inside the display region 20, a coupling effect is generated between the first pixel 11 under a conductive status and a second pixel 12 under a non-conductive status. Because the capacitance of the first pixel 11 is greater than the capacitance of the second pixel 12, the coupling effect will not generate an abnormal display in order to effectively avoid a larger brightness in a middle region of a display region and poor display effect because of a coupling effect between pixels having different capacitances in adjacent pixel units.

Furthermore, the multiple pixel units 10 can be divided into two display regions located at an upper and a lower screen, or located at a left and a right screen, or the multiple pixel units are evenly divided into four or above display regions. For a large display device, a screen splitting way can solve a wrong charging of the display image in a certain degree because of a serious resistor-capacitor delay. The screen splitting way can be designed according to an actual requirement. The display region can be multiple display regions located at an upper and a lower screen, or located at a left and a right screen, or evenly divided into four or above display regions. In one embodiment, the large display device can be divided into two half screens. The sizes of the half screens can be the same or different. Of course, according to an actual requirement, the multiple pixel units can be divided into multiple display regions, the number of the display regions can be four, six or eight. The number of the pixel units 19 in each display region is the same or different. In summary, no matter which screen splitting way is adopted, the only requirement is that in the display region 20, the first direction and the second direction are the same.

Furthermore, for different half screens, the number of the pixel units 10 can the same or be different. That is, in different embodiments, when dividing the display regions, the dividing way can be based on areas of the display regions, and dividing the display regions evenly. The dividing way can also be based on areas of the display regions, and dividing the display regions unevenly. When dividing the display regions based on the areas of the display regions, and dividing the display regions evenly or unevenly, the number of the pixel units 10 in each display region is the same or is different. In one embodiment, for the display regions that are divided evenly, the number of pixel units 10 of each display region is the same. For the display regions that are divided evenly, and each display region includes a same number of pixel units 10, controlling of each display region is convenient for beneficial to an even and smooth display effect.

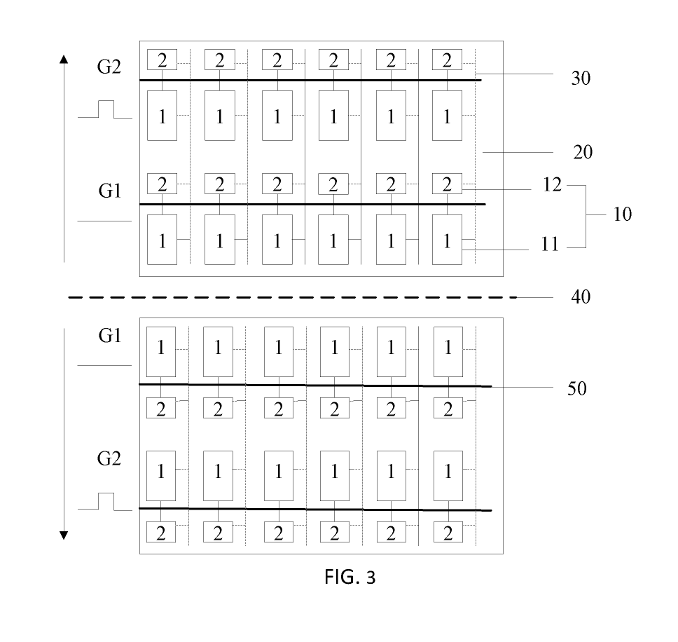

In the present invention, the first direction is an arrangement direction starting from the first pixel 11 to the second pixel 12 in the pixel unit 10. A second direction is a direction of a conductive sequence of the scanning lines 50. In order to avoid that the first pixel 11 after being charged is coupled with the second pixel 12 under a non-conductive status, the first direction and the second direction inside the at least two display regions are the same. Accordingly, with reference to FIG. 2 and FIG. 3 together, for different arrangement ways of the first pixels 11 and the second pixels 12 of the pixel units 10, for different display regions, the first direction and the second direction can be the same or be different.

For the display regions, when the first pixel 11 and the second pixel 12 of each pixel unit 10 is the same, defining that an arrangement direction starting from the first pixel 11 to the second pixel 12 in the pixel unit 10 is the first direction. With reference to FIG. 2, the display regions located at two sides of the screen splitting line 40, because the first directions at different display regions are the same, the second directions at different display regions are also the same. With reference to FIG. 3, because the first directions at different display regions are different, the second directions at different display regions are also different.

Furthermore, the at least two display regions 20 includes a first display region (not shown) and a second display region (not shown) which are disposed adjacently, and the second directions corresponding to the first display region and the second display region are . . . when the first directions of the different display regions 20 are different, if in the pixel unit 10 of the first display region that closes to the screen splitting line 40, the first pixel 11 is closer to the screen splitting line 40, the second directions of the first display region and the second display region are opposite and direct outwardly. If in the pixel unit 10 of the first display region that closes to the screen splitting line 40, the second pixel 12 is closer to the screen splitting line 40, the second directions of the first display region and the second display region are opposite and direct inwardly.

Furthermore, for different pixel units 10 in a same display region, arrangement ways of the first pixel 11 and the second pixel 12 can be different. The only requirement is that the conductive sequence of the scanning lines 50 starts from the first pixel to the second pixel.

Furthermore, in one embodiment, the first pixel 11 is a sub pixel, and the second pixel 12 is a main pixel, the pixel unit 10 is one of a red, a green and a blue pixels. Each pixel unit 10 includes a sub pixel and a main pixel, the capacitance of the main pixel is less than the capacitance of the sub pixel.

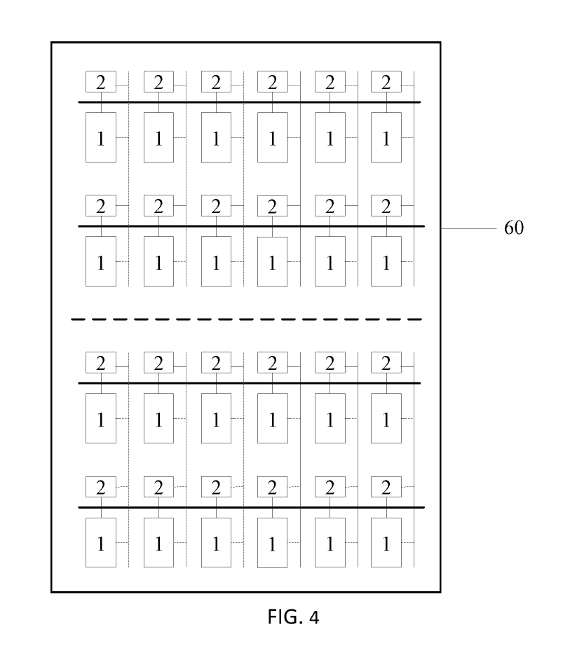

Based on the pixel array substrate described above, the present invention also discloses a display device. With reference to FIG. 4, and FIG. 4 is a schematic diagram of a display device according to an embodiment of the present invention. Wherein, the display device 60 includes anyone of the pixel array substrates described above. The pixel array substrate of the present invention can effectively solve a larger brightness in some display region of a large display device after being screen split and poor display effect.

Furthermore, a screen size of the display device is larger than 85 inch. In order to obtain a better display effect, a large display device require to be screen split, especially for a display device having a screen size larger than 85 inch. The screen splitting can increase the display effect. Furthermore, the display screen of the large display device is 85 inch to 100 inch. In another embodiment, the display screen of the large display device is 95 inch.

Furthermore, the display device is an LCD display device. The LCD display device has features of thin, space saving, power saving without generating high temperature, low radiation, beneficial for health and soft picture without hurting the eyes, and has a wide application prospect. When producing a large-sized LCD display device, if a screen splitting way is adopted, disposing the first direction and the second direction in different display regions to be the same can obtain a better display effect, which is beneficial to promote the large-sized LCD display device.

In summary, in the present invention, through disposing the first direction and the second direction to be the same in each of the at least two display regions, in the adjacent pixel units inside the display region, a coupling effect is generated between the first pixel under a conductive status and a second pixel under a non-conductive status. Because the capacitance of the first pixel 11 is greater than the capacitance of the second pixel, the coupling effect will not generate an abnormal display in order to effectively avoid a larger brightness in a middle region of a display region and poor display effect because of a coupling effect between pixels having different capacitances in adjacent pixel units.

The above embodiments of the present invention are not used to limit the claims of this invention. Any use of the content in the specification or in the drawings of the present invention which produces equivalent structures or equivalent processes, or directly or indirectly used in other related technical fields is still covered by the claims in the present invention.

1. A pixel array substrate, comprising:
multiple pixel units arranged as a matrix, wherein, the multiple pixel units are divided into at least two display regions, each pixel unit includes a first pixel and a second pixel, a capacitance of the first pixel is greater than a capacitance of the second pixel; and
multiple independent scanning lines located at different display regions, each scanning line is coupled to a corresponding first pixel and a corresponding second pixel of the pixel unit in a corresponding display region;
wherein, an arrangement direction starting from the first pixel to the second pixel in the pixel unit is defined as a first direction, a conductive sequence of the scanning lines is defined as a second direction; and
wherein, in each of the at least two display regions, the first direction and the second direction are the same, in different display regions, the second directions are the same.

2. The pixel array substrate according to claim 1, wherein, multiple pixel units are divided into two display regions located at an upper and a lower screen, or located at a left and a right screen; or the multiple pixel units are evenly divided into four or above display regions.

3. The pixel array substrate according to claim 2, wherein, for multiple pixel units dividing into two display regions located at an upper and a lower screen, or located at a left and a right screen, the number of the pixel units is the same or different.

4. The pixel array substrate according to claim 1, wherein, the at least two display regions includes a first display region and a second display region which are disposed adjacently, and the second directions corresponding to the first display region and the second display region are opposite and direct outwardly or inwardly.

5. The pixel array substrate according to claim 1, wherein, the first pixel is a sub pixel and the second pixel is a main pixel.

6. The pixel array substrate according to claim 2, wherein, the first pixel is a sub pixel and the second pixel is a main pixel.

7. The pixel array substrate according to claim 3, wherein, the first pixel is a sub pixel and the second pixel is a main pixel.

8. The pixel array substrate according to claim 4, wherein, the first pixel is a sub pixel and the second pixel is a main pixel.

9. A pixel array substrate, comprising:
multiple pixel units arranged as a matrix, wherein, the multiple pixel units are divided into at least two display regions, each pixel unit includes a first pixel and a second pixel, a capacitance of the first pixel is greater than a capacitance of the second pixel; and
multiple independent scanning lines located at different display regions, each scanning line is coupled to a corresponding first pixel and a corresponding second pixel of the pixel unit in a corresponding display region;
wherein, an arrangement direction starting from the first pixel to the second pixel in the pixel unit is defined as a first direction, a conductive sequence of the scanning lines is defined as a second direction; and
wherein, in each of the at least two display regions, the first direction and the second direction are the same, in different display regions, the second directions are different.

10. The pixel array substrate according to claim 9, wherein, multiple pixel units are divided into two display regions located at an upper and a lower screen, or located at a left and a right screen; or the multiple pixel units are evenly divided into four or above display regions.

11. The pixel array substrate according to claim 10, wherein, for multiple pixel units dividing into two display regions located at an upper and a lower screen, or located at a left and a right screen, the number of the pixel units is the same or different.

12. The pixel array substrate according to claim 9, wherein, the at least two display regions includes a first display region and a second display region which are disposed adjacently, and the second directions corresponding to the first display region and the second display region are opposite and direct outwardly or inwardly.

13. The pixel array substrate according to claim 9, wherein, the first pixel is a sub pixel and the second pixel is a main pixel.

14. The pixel array substrate according to claim 10, wherein, the first pixel is a sub pixel and the second pixel is a main pixel.

15. The pixel array substrate according to claim 11, wherein, the first pixel is a sub pixel and the second pixel is a main pixel.

16. The pixel array substrate according to claim 12, wherein, the first pixel is a sub pixel and the second pixel is a main pixel.

17. A display device, comprising a pixel array substrate as claimed in claim 1.

18. The display device according to claim 17, wherein the multiple pixel units are divided into at least two display regions, each pixel unit includes a first pixel and a second pixel, a capacitance of the first pixel is greater than a capacitance of the second pixel; and
multiple independent scanning lines located at different display regions, each scanning line is coupled to a corresponding first pixel and a corresponding second pixel of the pixel unit in a corresponding display region;
wherein, an arrangement direction starting from the first pixel to the second pixel in the pixel unit is defined as a first direction, a conductive sequence of the scanning lines is defined as a second direction; and
wherein, in each of the at least two display regions, the first direction and the second direction are the same, in different display regions, the second directions are the same;
wherein, the multiple pixel units are divided into two display regions located at an upper and a lower screen, or located at a left and a right screen; or the multiple pixel units are evenly divided into four or above display regions.

19. The display device according to claim 17, wherein, a size of a screen of the display device is greater than 85 inch.

20. The display device according to claim 17, wherein, the display device is an LCD display.
